(19) United States
(12) Patent Application Publication
(10) Pub. No.: US 2005/0006155 A1
(43) Pub. Date: Jan. 13, 2005

(54) Transport vehicle for scanner

(76) Inventor: Thomas E. Lenkman, St. Charles, MO (US)

Correspondence Address: Henry W. Cummings, 3313 W. Adams St., St. Charles, MO, 63301, US

(21) Appl. No.: 10/614,246

(22) Filed: Jul. 8, 2003

(51) Int. Cl. B60K 1/00

(52) U.S. Cl. 180/65.1

(57) ABSTRACT

A special purpose transport vehicle is provided having pneumatic lift devices which allow three modes of operation: position, scan, and drive. Electric motors provide forward, reverse, and turing motion during the drive mode.

### I FIELD OF THE INVENTION

This invention relates to a transport system, which is specially designed to transport a mobile CT scanner.

### II BACKGROUND OF THE INVENTION

U.S. Pat. No. 5,845,914 discloses a portable suspension system for highly sensitive equipment. This system is designed for transporting such equipment as an excimer laser device from one location to another, and will allow it to be secured in a truck van.

U.S. Pat. No. 5,398,986 discloses a mobile laser surgical center. This center is incorporated into a large truck van and is not designed to transport a discrete piece of equipment inside a hospital or a doctor's office.

### III SUMMARY OF THE INVENTION

### A. OBJECTS OF THE INVENTION

One object of the present invention is to provide a special purpose transport system which is joystick driven.

Another object of the present invention is to provide a special purpose transport system which allows for incremental user controlled movements across various terrains (asphalt, cement, carpeting, vinyl, etc.).

Another object of the present invention is to provide a special purpose transport system which allows the operator to control its speed and function and to maneuver around obstacles, negotiate ADA specification ramps and hallways.

Another object of the present invention is to provide a special purpose transport system which allows the operator to lower it to the floor and provide a stable platform from which to utilize the CT scanner.

### B. SUMMARY

Frequently, the need arises to move diagnostic equipment from one location in a hospital or clinic to another. Such equipment is extremely delicate and susceptible to shocks during motion. In addition, once the diagnostic equipment is at its new location, it is desirable to provide it with a stable platform. The present invention achieves these objects with a special purpose transport vehicel having pneumatic lift devices which allow three modes of operation: position, scan, and drive. Electric motors provide forward, reverse, and turning motion during the drive mode.

### IV. THE DRAWINGS

FIG. 1 is a perspective view of the present invention.

FIG. 2 is a perspective view of the upper portion of the electronics cabinet, showing controls contained therein.

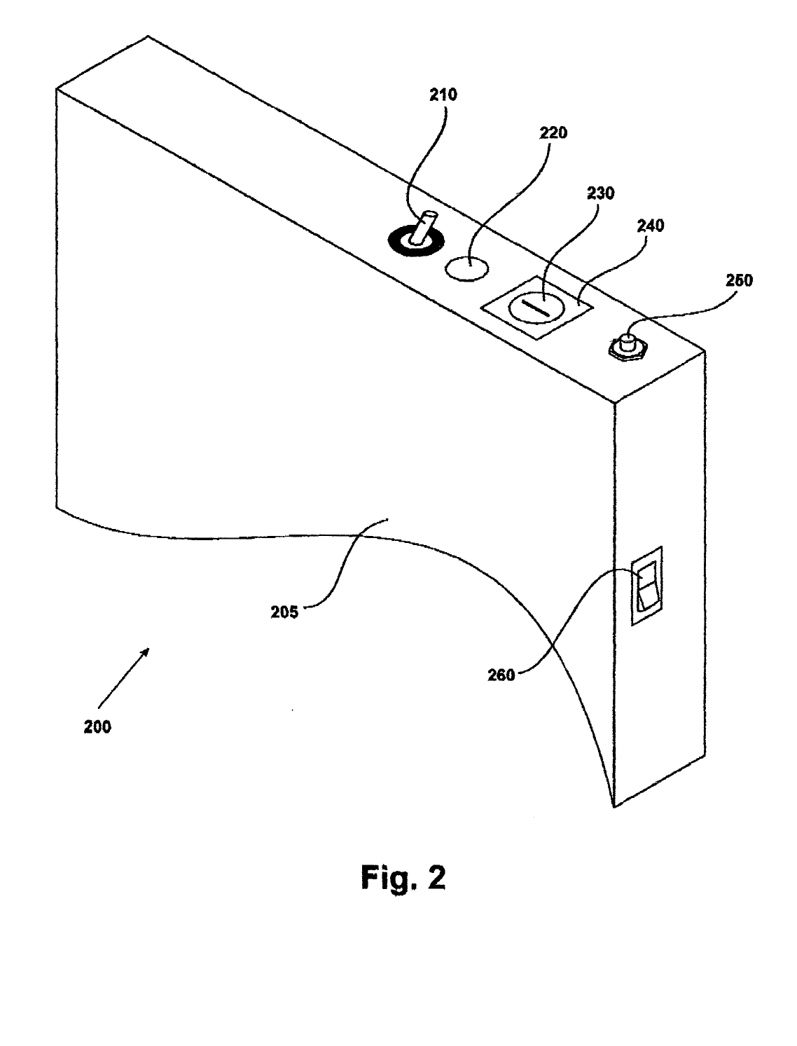

FIG. 3 is a detail view of the joystick assembly and cable assembly.

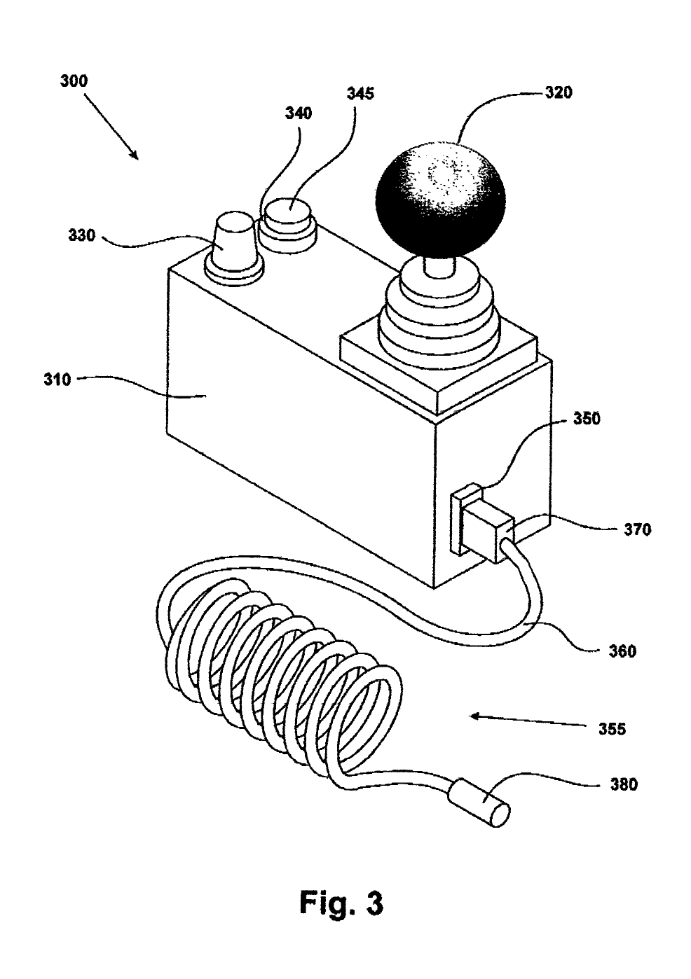

FIG. 4 is a pneumatic schematic of the present invention.

### V. DESCRIPTION OF PREFERRED EMBODIMENTS

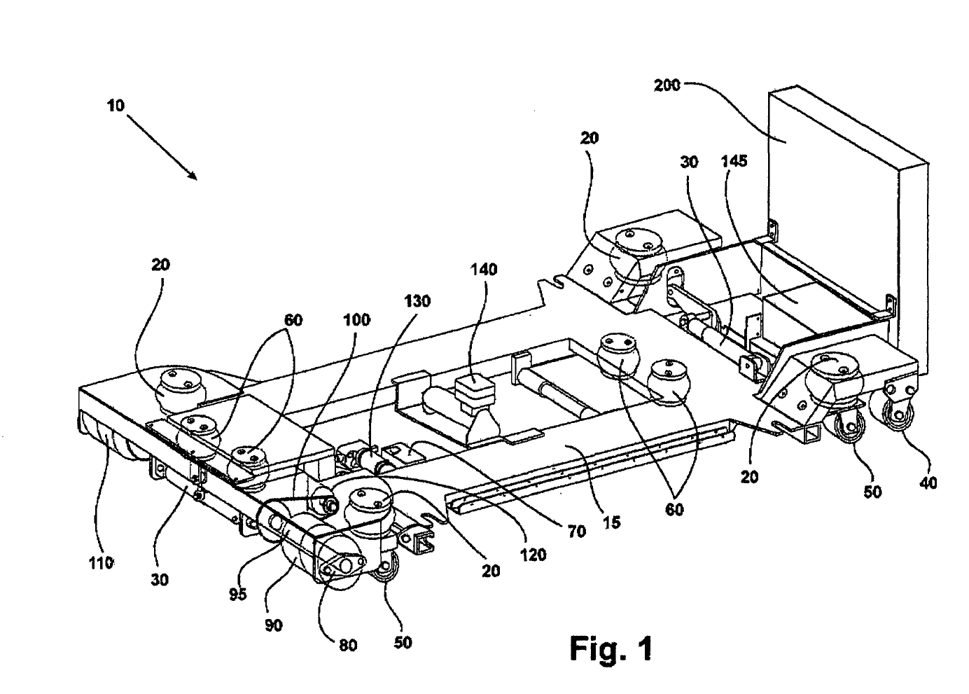

In accordance with the present invention, FIG. 1 shows the transport system, generally at 10. All major components of the transport system are mounted to chassis 15, with the exception of joystick assembly 300 and cable assembly 355. All components will be described during the discussion of the three modes of operation. Joystick assembly 300 is connected to electronics cabinet 200 by means of cable assembly 355. Cable assembly 355 comprises cable 360, cable jack 370, and DIN plug 380. Cable jack 370 is inserted in cable plug 350, mounted on joystick housing 310. DIN plug 380 is inserted in joystick DIN connector 220, mounted on top of electronics cabinet 200. Joystick assembly 300 may be held by the operator during movement, or left mounted to electronics cabinet enclosure 205.

Prior to operation, the user ensures joystick knob 320 is in the center (neutral) position. Key switch 230 is turned to the “ON” position. The user further ensures that operator variable speed control knob 330 is turned fully counterclockwise prior to pressing on/off button 340. Circuitry contained within electronics cabinet 200 performs a system self-check, after which status indicator lamp 345 turns on solid green, and electrical power is supplied to all components. If a fault exists in the system, status indicator lamp 345 will flash a code. User documentation provides information as to the nature of the fault, based on the flashing code.

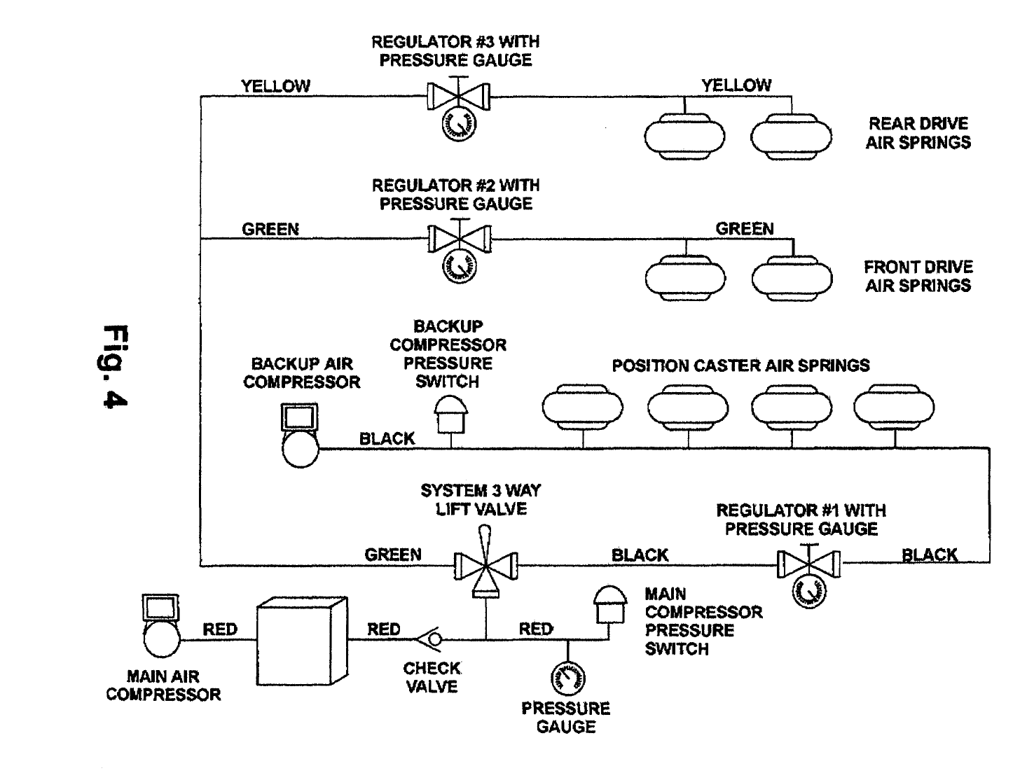

Drive mode is selected by placing drive system mode switch 210 in the “DRIVE” position. This energizes main air compressor 140, which pressurizes air reservoir 145. Constant air pressure is maintained in air reservoir 145 by means of a Main Compressor pressure switch (FIG. 4) which energizes main air compressor 140 when pressure drops below a preset value.

Air reservoir 145 supplies air to drive air springs 60, which lower drive wheels 90 and 110, as well as lowering transport casters 40, raising the transport system from the floor. The user moves joystick knob 320 in the desired direction of motion. If greater or lesser speed is desired, the user may turn operator variable speed control knob 330 in the appropriate direction. Joystick motion applies electrical power to right drive motor 120 and/or left drive motor (not shown). Motor rotation is applied to right axle 95 by means of right drive chain 100. Right axle 95 is secured by axle bearing 80. In a similar manner, the left drive motor applies power to left drive wheel 110. Turning is accomplished by user motion of the joystick, which applies differential power to the drive motors, causing the unit to turn. Releasing joystick knob 320 at any time causes the transport system to stop. If no joystick movement is detected for seven or more seconds, a stand-by mode of operation is entered. To resume movement, press on/off button 340. During movement, shock isolation is provided to the CT scanner by means of shock absorbers 30 and pneumatic cushioning inherent in drive air springs 60.

The second mode of operation is known as position mode, which allows manual movement of the transport system for precise positioning in confined areas and during patient treatment. Moving drive system mode switch 210 to “POSITION” allows air from air reservior 145 to be routed to position caster air springs 20, lowering position casters 50. The transport system can then be moved in any direction by manual means.

The third mode of operation is known as scan mode, and is the only mode recommended for use of the diagnostic equipment. Moving drive system mode switch 210 to SCAN deflates all air springs, lowering the transport system so that it rests on the floor, providing a stable platform.

In the event of loss of electrical power, the user may press emergency only wheel position switch 260, which routes air from air reservoir 145 to position caster air springs 20, lowering position casters 50. The transport system can then be moved in any direction by manual means.

In the event of a main air compressor 140 or air reservoir 145 failure, backup air compressor 130 will provide air pressure to position caster air springs 20, lowering position casters 50 and allowing manual movement of the transport system.

All system electrical components are protected by 50 amp circuit breaker 250. Electronics cabinet 200 also contains a cord reel and a battery charger (not shown), which are used to maintain a charge on the system battery. Battery charge indicator 240 informs the user of the status of the battery charge.

1. A transport system comprising:
A self-propelled transport assembly, and
controlling means to raise and lower motive components to facilitate different modes of operation.

2. A transport system according to claim 1 wherein said raising and lowering means comprise a system of air compressors and pneumatic lift devices.

3. A transport system according to claim 2 wherein said air compressors provide sufficiently pressurized air to activate said pneumatic lift devices via a system of pneumatic plumbing and an air reservoir.

4. A transport system according to claim 3 wherein said motive components comprise unpowered casters and at least two powered drive units.

5. A transport system assembly according to claim 4 wherein said unpowered casters are lowered by means of said pneumatic lift devices to allow manual positioning.

6. A transport system according to claim 5 wherein each said powered drive unit comprises a variable speed reversible electric motor, a drive chain, an axle, and a wheel.

7. A transport system comprising according to claim 2 wherein said air compressors are powered by an electrical system comprising a battery, a battery charger, and battery charger controls and indicators.

8. A transport system comprising according to claim 6 wherein said drive units are powered by an electrical system comprising a rechargeable battery, charging means, controls and indicators.

9. A transport system comprising according to claim 8 wherein said charging means comprises a battery charger and a cord reel which may be plugged into an electrical outlet.

10. A transport system according to claim 1 wherein said controlling means allow the user to properly control the battery charger.

11. A transport system according to claim 10 wherein said controlling means comprise a joystick assembly having control means to control the speed, direction, forward and reverse motion of the unit.

12. A transport system according to claim 10 wherein said controlling means also comprises an electronics cabinet control panel having means to energize electrical power to the unit, connect said joystick, protect electrical circuitry, view battery charge status, and select mode of operation.

13. A transport system according to claim 5 wherein the user can select one of the following: unpowered casters for manual positioning; motorized wheels for powered transport; or treat position for medical device operation.

14. A transport system according to claim 13 including a selector switich which enables the user to select the desired mode of operation.
